(19) United States
(12) Patent Application Publication
(10) Pub. No.: US 2010/0321153 A1
(43) Pub. Date: Dec. 23, 2010

(54) APPARATUS AND METHOD FOR PERFORMING A SEQUENCE OF OPERATIONAL INSTRUCTIONS

(75) Inventors: Sanjay Bose, West Edison, NJ (US); Joseph Carbonara, Manalapan, NJ (US); A. Arthur Kressner, Westfield, NJ (US)

Correspondence Address: CANTOR COLBURN LLP, 20 Church Street, 22nd Floor, Hartford, CT, 06103, US

(73) Assignee: CONSOLIDATED EDISON COMPANY OF NEW YORK, INC., New York, NY (US)

(21) Appl. No.: 12/489,025

(22) Filed: Jun. 22, 2009

(51) Int. Cl. G05B 19/00; G06F 9/30; G01S 5/00

(52) U.S. Cl. 340/5.61; 712/245; 340/5.1; 712/E09.016

(57) ABSTRACT

An apparatus and method of performing a sequence of steps is provided. The apparatus includes a controller that stores the sequence of steps and displays the steps in order to the operator. The apparatus includes a positioning module that confirms the operator position and a reader module to confirm the identification of the equipment to be worked on. An programmable key is also provided for storing a sequence of unlock codes that allows the operator open the equipment and cabinets in the same sequence as the sequence of steps.

### BACKGROUND OF THE INVENTION

The subject matter disclosed herein relates to an apparatus and method for performing a sequence of operational instructions, and in particular to an apparatus and method of performing a sequence of operational instructions where the operations must be performed in a sequence at different physical position/location in a desired order.

Many industries have processes that need to be performed by personnel to accomplish a task. To ensure a quality and reliability, many organizations have developed written processes that instruct the personnel on how to accomplish the task. In some application these processes need to be performed in a defined order at defined locations to avoid damaging equipment or disrupting downstream processes.

In some industries, such as the chemical, petroleum, electrical power production and electrical delivery industries, some tasks involve a complex set of instructions that must be conducted in the desired order at locations that may be physically separated by large physical distances from each other. To further complicate the task for personnel, the equipment on which they are performing tasks look identical or substantially similar to other equipment installed at the facility. If personnel become disoriented as to their position, or are not paying sufficient attention, they may perform the desired task (e.g. closing a valve or actuating a switch) at the wrong location and on the wrong equipment. In these circumstances, damage to the equipment and disruption of the processes may occur. It is estimated that across multiple process industries, in these types of situations, that 50% of errors occur due to personnel mistakenly believing that they are positioned in the right location to perform the task.

To avoid these types of errors, process industries utilize written instructions, sometimes referred to as “Operational Orders”, in combination with a system of checks and balances. For example, the equipment where tasks are performed may have locks, such as combination locks for example, that prevent actuation of the equipment without removing the lock. In these instances, the Operational Order sheet includes the combination to the lock so the personnel can access the desired equipment. In some instances, the personnel may be in contact with control center personnel that validate the personnel's actions. Despite these precautions, errors still may occur due to the sometimes repetitive nature of the Operational Orders. For example, where combination locks are used, the personnel may memorize the codes, or fail to zero-out the combination, after repeatedly performing the same procedure.

Accordingly, while existing operational process procedures are suitable for their intended purposes there remains a need for improvements, particularly in ensuring that personnel perform the desired task at the desired location in the desired sequence.

### BRIEF DESCRIPTION OF THE INVENTION

According to one aspect of the invention, an instruction and tracking apparatus is provided. The apparatus includes a positioning module, a reader module, and a display. A controller is operably coupled to the positioning module, the reader module and the display. The controller includes a processor responsive to executable computer instructions when executed on the processor for displaying a first operational sequence instruction on the display in response to receiving a first signal.

According to another aspect of the invention, an instruction and tracking apparatus is provided having an instruction unit and a key. The instruction unit comprises a positioning module, a reader module, and a display. A first controller is operably coupled to the positioning module, the reader module and the display. The first controller includes a first processor responsive to executable computer instructions when executed on the first processor for displaying a first process instruction on the display in response to receiving a first signal. The key comprising a receiver, a transmitter, and a second controller. The second controller is electrically coupled to the receiver and the transmitter. The second controller also includes a second processor and memory, the second processor being responsive to executable computer instructions when executed on the second processor for storing a sequence of codes in the memory in response to the first signal.

According to yet another aspect of the invention, a key for use with operational sequence instructions is provided. The key includes a housing and an engaging member coupled to the housing. A controller is positioned in the housing, the controller having a processor electrically coupled to memory. The processor is responsive to executable computer instructions when executed on the processor for storing a sequence of unlock codes in the memory in response to a first signal, the controller further includes a transmitter electrically coupled between the controller and the engaging member. Wherein the processor is responsive to executable computer instructions when executed on said processor for transmitting a first unlock code from the sequence of unlock codes through the engaging member when the engaging member contacts a first lock, the processor is further responsive to executable computer instructions when executed on the processor for erasing the first unlock code from the sequence of unlock codes when the first unlock code is accepted by the first lock.

According to yet another aspect of the invention, a method for performing a sequence of operational instructions is provided. The method includes the step of storing the sequence of operational instructions, the sequence of operational instructions includes a process instruction, an equipment identification data and a position where the instruction is to be performed. A first process instruction associated with a first operational instruction from said sequence of operational instructions is displayed, wherein the first operational instruction includes a first position and a first identification data. A second position is determined. An identification signal is received from a first equipment.

According to yet another aspect of the invention, a method for performing a sequence of operational instructions is provided. The method includes the steps of receiving a set of operational instructions, wherein the set of operational instructions includes a plurality of steps that are executed in order at particular locations. A plurality of unlock codes is stored in a key, wherein each of the plurality of unlock codes is associated with one of the plurality of steps. A first unlock code is transmitted from said plurality of unlock codes when the key is inserted in a first lock. The first unlock code is erased from the key if the first unlock code is accepted by the first lock. A first alarm is initiated if the first unlock code is not accepted by the first lock.

According to yet another aspect of the invention, a method for performing a sequence of operational instructions is provided. The method includes the steps of storing the sequence of operational instructions in a first memory, the sequence of operational instructions includes a process instruction, an equipment identification data and a position where the process instruction is to be performed. A plurality of unlock codes is stored in a key memory, wherein each of the plurality of unlock codes is associated with one of the sequence of operational instructions. A first process instruction associated with a first operational instruction from said sequence of operational instructions is displayed, wherein the first operational instruction includes the first process instruction, a first position and a first identification data. A second position is determined. An identification signal is received from a first equipment.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram illustration of a facility using operational orders in accordance with an exemplary embodiment;

FIG. 2 is a schematic illustration of an apparatus for assisting personnel in performing operation orders in accordance with an embodiment;

FIG. 3 is a schematic illustration of a controller for the apparatus of FIG. 2;

FIG. 4 is a schematic illustration of a key to assist personnel in performing operation orders in accordance with an embodiment;

FIG. 5 is a flow diagram illustration of a method of performing operational orders in accordance with an embodiment;

FIG. 6 is another flow diagram illustration of a method of performing operational orders in accordance with an embodiment; and,

FIG. 7 is yet another flow diagram illustration of a method of performing operational orders in accordance with an embodiment;

The detailed description explains embodiments of the invention, together with advantages and features, by way of example with reference to the drawings.

### DETAILED DESCRIPTION OF THE INVENTION

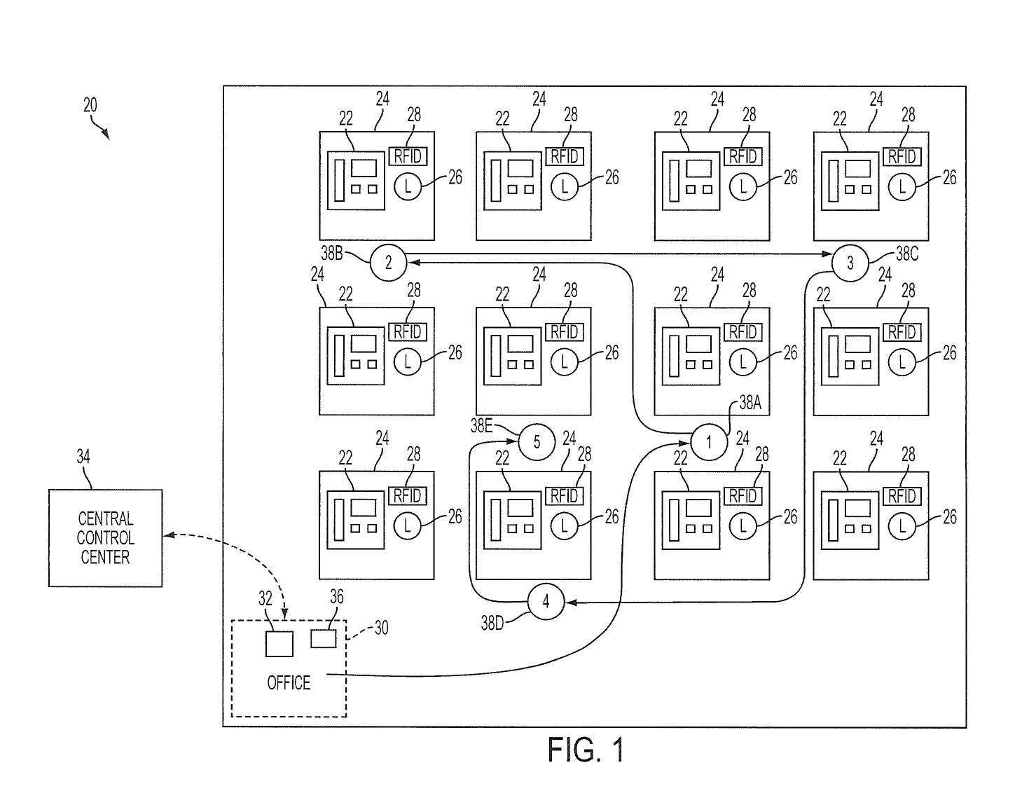

Operational orders are a set of instructions that are carried out by personnel with a facility to accomplish a certain task where a series of steps are to be performed in sequence, usually at different physical locations. Operational orders are used in a variety of industries, including but not limited to chemical, pharmaceutical, petroleum, electrical power production and electrical power distribution. An exemplary facility 20 is illustrated in FIG. 1. The facility 20 includes a plurality of pieces of equipment 22 that may be identical or look similar. Equipment 22 includes, but is not limited to circuit breakers, switches, valves and the like. In the exemplary embodiment, the equipment 22 is housed in a cabinet 24 that is arranged to secure the equipment 22. The cabinet 24 includes a lock 26 that prevents unauthorized or accidental access to the cabinet 24 and the equipment 22. As will be discussed in more detail below, in the exemplary embodiment the cabinet 24 and/or the equipment 22 will have an identification device 28 that allows the personnel to ascertain which equipment 22 is located at that position. The identification device 28 may be a radio-frequency identification tag (“RFID”), a bar code, or a magnetic strip for example, that transmits an identification signal. It should be appreciated that the lock 26 may be incorporated into the equipment 22 rather than the cabinet 24.

Personnel typically operate from an office or work area 30. In the exemplary embodiment, the office 30 includes telecommunications devices such as a computer 32 that is coupled to receive and transmit data, such as operational orders for example, with a central control center 34. In one embodiment, the office also includes a printer 36 coupled to the computer 32 for printing the operational orders. Once an operational order is issued, either by the facility personnel or the central control center 34, the personnel proceed through the each of the steps 38A-38D on the operational order in sequence at the desired equipment 22. It should be appreciated that the operational order may include more or less steps 38. In the exemplary embodiment, the facility 20 is an electrical substation and the steps 38 are directed to the restoration of a feeder circuit fault. The steps 38 may be directed to a variety of tasks including the opening of circuit breakers, checking relays and target flags, grounding of circuits, and applying high voltage pulses. While the descriptions herein may be directed to a substation operation, the claimed invention should not be so limited and may be applied in any application where a series of tasks are performed in order.

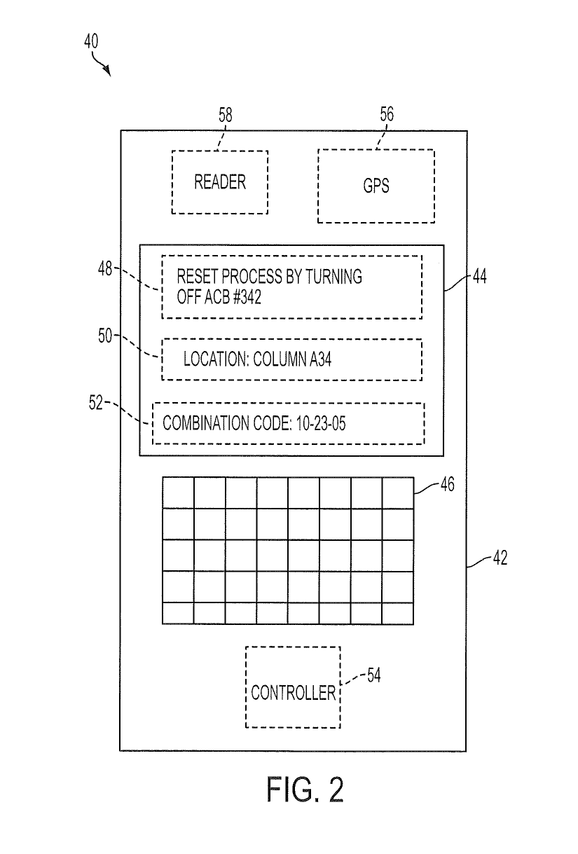

To assist the personnel in executing the operational order, the personnel may utilize a handheld device, such as instruction unit 40 illustrated in FIG. 2. The unit 40 includes a housing 42 with a display 44 and a user interface 46. It should be appreciated that while the display 44 and the user interface 46 are illustrated as separate components, this is for exemplary purposes and other configurations are contemplated, such as a touch screen that is capable of both displaying information and receiving input from the user for example. The user interface may be an LED (light-emitting diode) display, an LCD (liquid-crystal diode) display, a CRT (cathode ray tube) display, or the like. As will be explained in more detail below, the display 44 conveys information to the personnel, including but not limited to the actions or tasks they should be performing 48, the location the tasks should be performed 50, the combination for the cabinet where the task should be performed 52, and their present location for example. As will be discussed in more below, in some embodiments, the unit 40 may provide context based information such that only information needed by the personnel to complete their current task is provided. This provides advantages in assisting personnel in avoiding errors, skipping steps or ignoring errors.

The unit 40 also includes a controller 54 electrically coupled to a positioning module 56 and a reader module 58. In one embodiment the position circuit 56 is a global positioning system (“GPS”) circuit that uses satellite based technology to accurately determine the position of the unit 40. However, the positioning module 56 may also be a cellular based circuit that uses cellular telecommunications antennas to triangulate a position. The positioning circuit may also be based on RFID sensors, infrared sensors, radio-frequency beacons, time-difference-of-arrival systems, ultra-wideband systems, IEEE 802.11 based systems or a hybrid of the foregoing. In another embodiment, the reader module 58 is an RFID reader that receives information from an RFID tag, such as identification device 28 for example. The reader module 58 may also be a barcode reader, or a magnetic strip reader for example.

As used herein, the term “module” means a circuit (whether integrated or otherwise), a group of such circuits, a processor(s), a processor(s) implementing software, or a combination of a circuit (whether integrated or otherwise), a group of such circuits, a processor(s) and/or a processor(s) implementing software. The term “circuit” means either a single component or a multiplicity of components, either active and/or passive, that are coupled together to provide or perform a desired function. Further, the term “scan” or “scanned” refers to the acquisition of data by the reader module 58, the acquisition of data may occur wirelessly, such as with an RFID tag, bluetooth system, or IEEE 802.11 system for example, or may include the connection of a physical medium, such as a serial, parallel, universal serial bus (USB) or Ethernet cable for example.

The reader module 58 and positioning module 56 are electrically coupled to a controller 54. The unit 40 operation is controlled by controller 54. Controller 54 is a suitable electronic device capable of accepting data and instructions, executing the instructions to process the data, and presenting the results. Controller 54 may accept instructions through user interface 46, or through other means such as but not limited to electronic data card, voice activation means, manually-operable selection and control means, radiated wavelength and electronic or electrical transfer. Therefore, controller 54 can be a microprocessor, microcomputer, a minicomputer, an optical computer, a board computer, a complex instruction set computer, an ASIC (application specific integrated circuit), a reduced instruction set computer (RISC), an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer, a cellular phone, a personal digital assistant (PDA), or a hybrid of any of the foregoing.

Controller 54 is capable of converting the analog voltage or current level into a digital signal. Alternatively, circuits, such as positioning module 56 and reader module 58 may be configured to provide a digital signal to controller 54, or an analog-to-digital (A/D) converter (not shown) maybe coupled to convert an analog signal into a digital signal for processing by controller 54. Controller 54 uses the digital signals act as input to various processes for controlling the unit. The digital signals represent one or more unit 40 data including but not limited to positioning data, equipment identification data and the like. It should be appreciated that while the controller 54, the positioning module 56, and the reader module 58 are shown and described as separate modules or components, this is for the purpose of clarity and in some embodiments, the controller 54, the positioning module 56, and the reader module 58 are integrated into a single module.

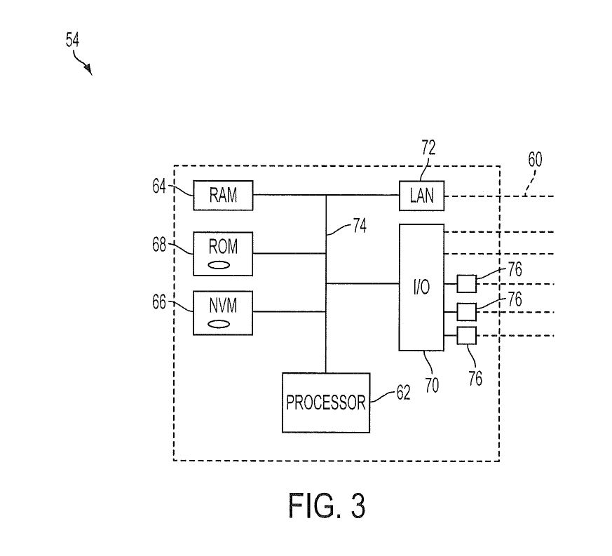

Controller 54 may be operably coupled with one or more systems or components within the facility 20 by data transmission media 60 (FIG. 3). Data transmission media 60 includes, but is not limited to, twisted pair wiring, coaxial cable, and fiber optic cable. Data transmission media 60 also includes, but is not limited to, wireless, radio and infrared signal transmission systems. In the embodiment shown in FIG. 1, transmission media 60 may couple the controller 54 to computer 32 or central control center 34 for example. Controller 54 is configured to provide operating signals to these components and to receive data from these components via data transmission media 60. Data transmission media 60 interconnects one or more remote computers, which are configured to communicate with controller 54 using a well-known computer communications protocol such as TCP/IP (Transmission Control Protocol/Internet (̂) Protocol), RS-232, ModBus, and the like. Additional units 40 may also be connected to data transmission media 40 with the controllers 54 in each of these units 40 being configured to send and receive data to and from remote computers and other units 40. The data transmission media may be connected to the Internet. This connection allows controller 54 to communicate with one or more remote computers connected to the Internet.

In general, controller 54 accepts data from positioning module 56 and reader module 58, is given certain instructions for the purpose of comparing the data from circuits 56, 58 to predetermined operational parameters. Controller 54 provides operating signals to display 44, indicating, for example, an alarm when if the personnel scans the wrong equipment 22 for a given task. The controller 38 compares the operational parameters to predetermined variances (e.g. position of personnel to where they should be for the task to be performed) and if the predetermined variance is exceeded, generates a signal that may be used to indicate an alarm to an operator or the central control center 34. Additionally, the signal may initiate other control methods that adapt the operation of the unit 40 such as displaying a map with a path to the desired equipment 22 to compensate for the out of variance operating parameter, such as the personnel making a wrong turn for example. As will be described in more detail below, to prevent damage to the end use application, the controller 54 may initiate alarms or disable the operating order instructions in the event that the personnel attempt to perform tasks out of sequence or on the wrong equipment 22.

Referring now to FIG. 3, a schematic diagram of controller 54 is shown. Controller 54 includes a processor 62 coupled to a random access memory (RAM) device 64, a non-volatile memory (NVM) device 66, a read-only memory (ROM) device 68, one or more input/output (I/O) controllers 70, and a LAN interface device 72 via a data communications bus 74.

I/O controllers 70 are coupled to the user interface 46 for providing digital data between these devices and bus 74. I/O controllers 70 are also coupled to analog-to-digital (A/D) converters 76, which may receive analog data signals from circuits 56, 58.

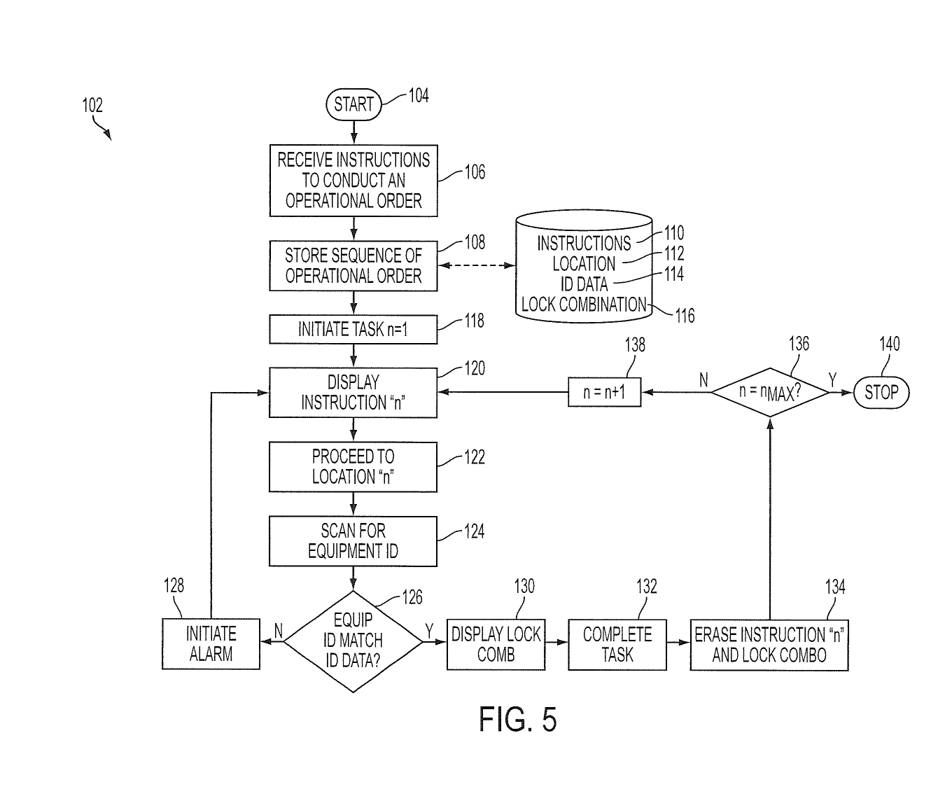

ROM device 68 stores an application code, e.g., main functionality firmware, including initializing parameters, and boot code, for processor 62. Application code also includes program instructions as shown in FIGS. 5-7 for causing processor 62 to display process instructions 48 and other pertinent data and to generate of alarms if the personnel deviate from the operational order.

NVM device 66 is any form of non-volatile memory such as an EPROM (Erasable Programmable Read Only Memory) chip, a disk drive, or the like. Stored in NVM device 66 are various operational parameters for the application code. The various operational parameters can be input to NVM device 66 either locally, using user interface 46 or computer 32, or remotely via a local area network or a wide area network using remote computer at the central control center 34. It will be recognized that application code can be stored in NVM device 66 rather than ROM device 68.

Controller 54 includes operation control methods embodied in application code, such as those shown in FIGS. 5-7 for example. These methods are embodied in computer instructions written to be executed by processor 62, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

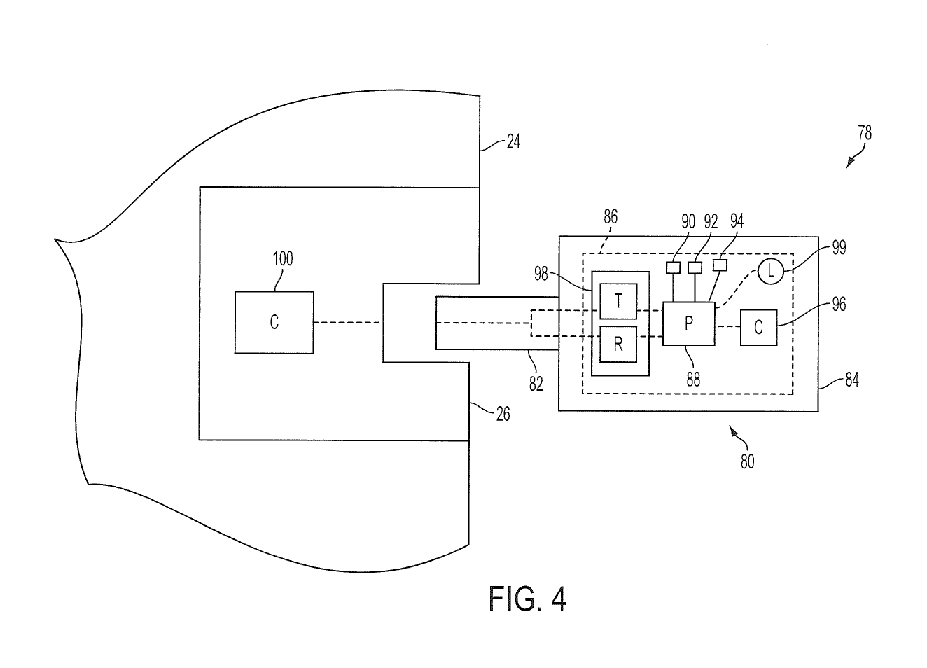

One situation that may result in errors in the execution of the operational order is when personnel memorize the combinations used on the mechanical locks 26 that secure the cabinets 24. One prior art method utilized a mechanical key system where the personnel started with the first key which then fit the desired lock. By unlocking the first cabinet, the personnel obtained a second key that was used to unlock the equipment associated with the next task. While this worked well, it was cumbersome and would only work with pre-designated processes. Where the operational order may change the order or the types of equipment, the string of mechanical keys would not function properly. Shown in FIG. 4 is an electronic, or programmable key 78 that provides advantages over both the combination and the mechanical-key lock systems.

The key 78 is generally of the same size and shape as a traditional mechanical key with a handle portion 80 and a blade or engaging member 82. The handle portion 80 includes a housing 84 that is sized to contain a controller 86. The controller 86 includes a processor 88 and memory, including RAM 90, ROM 92, and NVM 94. The controller 86 may be configured to operate substantially similar to the controller 54 described herein above in that the processor 88 is responsive to executable computer instructions when executed on the processor 88. The executable computer instructions may be stored in memory 90, 92, 94. In the exemplary embodiment, the personnel insert the key 78 into a docking station (not shown) coupled to computer 32 to program the key 78 via communications module 96. The communications module 96 couples to a data transmission media that includes, but is not limited to, wired, radio and infrared signal transmission systems. In another embodiment, the key 78 may be programmed wirelessly via communications module 96 to a remote computer, such as one in the central control center 34 for example. Controller 86 is configured to provide operating signals and to receive data. As will be discussed in more detail below, in the exemplary embodiment, the controller 86 is configured to receive a sequence of unlock codes that correspond to the sequence of tasks to be performed by the personnel. In one embodiment, the controller 86 is configured to erase each unlock code in the sequence when the unlock code has been accepted by a lock.

Coupled to the processor 88 are a transmission and receiver module 98. The transmission and receiver circuit 98 is configured to transmit an unlock code to a contact on the engaging member 82 when the engaging member 82 is inserted into and contacts lock 26. The unlock code is transmitted to lock circuitry 100. If the transmitted unlock code matches the code programmed into the lock 26, the lock circuitry 100 acknowledges the unlock code and transmits an acceptance signal. The lock circuitry 100 then releases the mechanical portion (not shown) of the lock 26 to allow the cabinet 24 to open. In one embodiment, the engagement portion includes projections that engage corresponding openings in the mechanical portion of the lock 26 to allow the lock 26 to be moved into an unlocked position. In one embodiment, the controller 86 includes a visual indicator 99, such as an light emitting diode (LED) for example, that is activated when said unlock code is not accepted.

As will be discussed in more detail below, in the exemplary embodiment, the controller 86 is configured to receive a sequence of unlock codes that correspond to the sequence of tasks to be performed by the personnel. The unlock codes are an electronic equivalent to the mechanical combination code. In one embodiment, the controller 86 is configured to erase each unlock code in the sequence when the unlock code has been accepted by a lock, such that each unlock code has only a one time use. In another embodiment, the unlock codes are encrypted to prevent the unauthorized duplication or copying of the unlock codes. This provides advantages over the combination lock system and the mechanical-key system in that the unlock codes are an electronic signal which cannot be memorized by the personnel. Since a single key is used with all the cabinets 24, the inconvenience of resetting the mechanical keys is avoided. It should be appreciated that the electronic key 78 may be used by itself with a paper operational order or in combination with the instruction unit 40.

Referring now to FIG. 5-7, methods of performing the operational order will be described. A method 102 of performing the operational order with a system having combination locks 26 is shown in FIG. 5. The method 102 begins in start block 104 and proceeds to block 106 where the instructions to conduct an operational order are received. The sequence of instructions are transmitted to the unit 40 and stored, such as in RAM 64 for example, in block 108. Each of the steps in the sequence of instructions for the operational order may include multiple data portions, including but not limited to process instruction 110, equipment location 112, identification data 114, and a lock combination 116. In the exemplary embodiment, the process instruction 110 is a text description of the tasks to be performed by the personnel. In one embodiment, the data 110, 112, 114, 116 are grouped as associated logical data sets, such that a first process instruction 110 is associated with a first equipment location 112, a first identification data 114 and a first lock combination 116 for example. The location information 112 may include the positioning coordinates for the GPS and a text field with a physical description for the personnel. The ID data may include data corresponding to the RFID tag 28.

Once the sequence of instructions data is stored, the method 102 proceeds to block 118 where unit 40 initiates the first task, n=1. The method 102 then displays the instructions for the first task on the operational order on the display 44 of the unit 40 in block 120. The personnel then proceed to the location of the desired cabinet 24 containing the equipment 22 in block 122. In one embodiment, the unit 40 generates a graphical display mapping a path for the personnel from their current position to the position of the task to be performed, such as by using the GPS coordinates 112 to guide the personnel. The operator scans the identification device 28, such as an RFID tag for example, in block 124. Query block 126 determines whether the data from the identification device 28 matches the identification data 114. In one embodiment, the query block 126 also compares the current location of the personnel to the location data 112 to determine if the personnel are in substantially the same location as the location data 112. If either the location or identification data does not match, then the personnel are at the wrong location and the method 102 proceeds to block 128 where an alarm is initiated to alert the personnel. In one embodiment, each time the alarm is initiated, the unit 40 stores this data for later evaluation, such as for examining the effectiveness of personnel training for example. In another embodiment, the initiation of the alarm also causes an alarm to be transmitted to the central control center 34. In yet another embodiment, the unit 40 generates a graphical display mapping a path from their current position to the correct position. The method 102 then loops back to block 120 where the instruction is displayed.

If query block 126 returns a positive, meaning the personnel are at the right location, the method 102 proceeds to block 130 where the values of the combination lock for the cabinet 24 are displayed on the display 44. The personnel then complete the task in block 132 and the unit 40 erases the task and the combination information from memory in block 134. The method 102 then proceeds to query block 136 where it is determined whether the task that was just performed was the last task. If the query block returns a negative, the method 102 proceeds to block 138 where the method 102 increments to the next task in the sequence of instructions and loops back to block 120 to initiate the next task. In one embodiment, the unit 40 graphical display mapping a path from the personnel's current position to the location of the next task to be performed. If the query block 136 returns a positive, the method 102 proceeds to termination block 140 and stops.

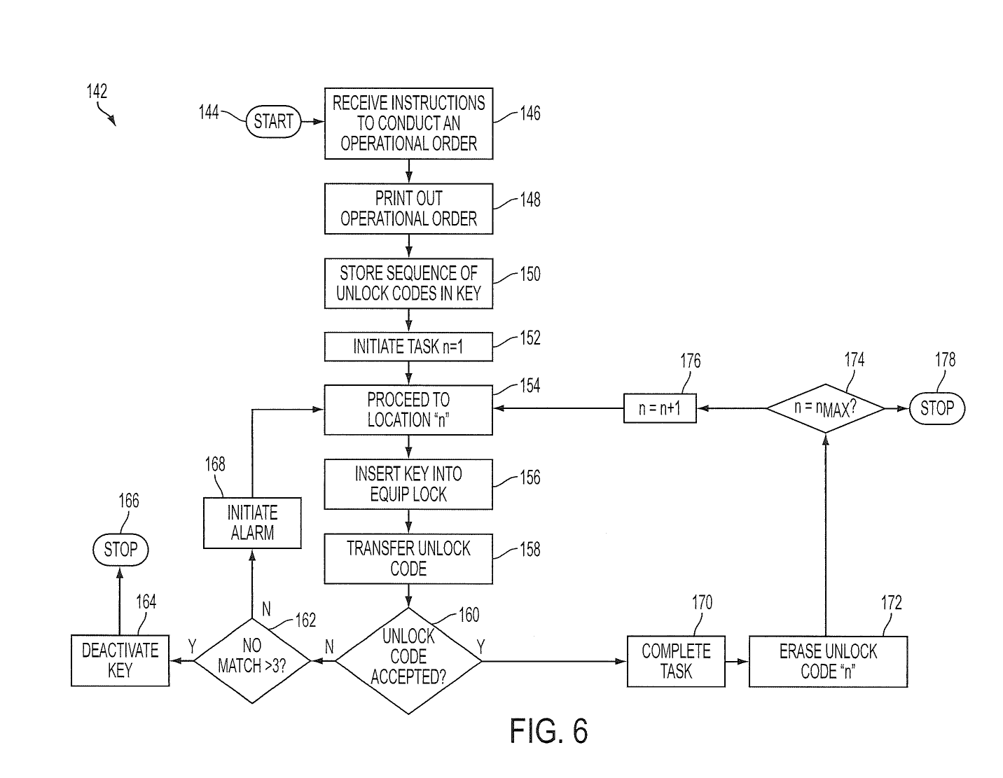

Another method 142 for performing the operational order using the key 78 is illustrated in FIG. 6. The method 142 begins in start block 144 and proceeds to block 146 where instructions are received to conduct an operational order. The method 142 then proceeds to block 148 where printer 36 prints out the operational order, including the sequence of steps to be performed by personnel, into a hardcopy report. The method 142 then stores a sequence of unlock codes in the memory of the key 78, such as RAM 90 for example, in block 150. Each of the unlock codes being associated with one of tasks in the sequence of steps in the operational order.

With the unlock codes stored, the method 142 proceeds to block 152 where the personnel begin the first task and proceed to the location of the first task in block 154. Once the personnel arrive at the equipment 22 the personnel inserts the key 78 into the lock 26 in block 156. The key 78 transmits the unlock code associated with the step in the operational order to the lock 26 in block 158. It is determined whether the unlock code is accepted by the lock 26 in query block 160.

If query block 160 returns a negative, meaning the unlock code was not accepted. The method 142 then proceeds to the query block 162 to determine if there have been more than three unsuccessful attempts to open a lock. In the exemplary embodiment, each time an unsuccessful attempt is made, the key 78 stores the information, such as in RAM 90 for example. In one embodiment, if there have been more than three unsuccessful attempts to open locks, the method 142 proceeds to block 164 where the key 78 is deactivated and the method 142 terminates in block 166. If the query block 162 returns a negative, the method 142 proceeds to block 168 where an alarm is initiated and loops back to block 154.

If the query block 160 returns a positive, meaning that the unlock code was accepted by the lock 26, then cabinet 24 opens and the method 142 proceeds to block 170 where the personnel complete the task. Once the cabinet is unlocked, the key 78 erases the unlock code that was accepted by the lock 26 in block 172. The method 142 then proceeds to query block 174 where it is determined whether the task that was just performed was the last task in the sequence of instructions. If the query block returns a negative, the method 142 proceeds to block 176 where the method 142 increments, n=n+1, to the next task in the sequence of instructions and loops back to block 1154 to initiate the next task. If the query block 174 returns a positive, the method 142 proceeds to termination block 178 and stops.

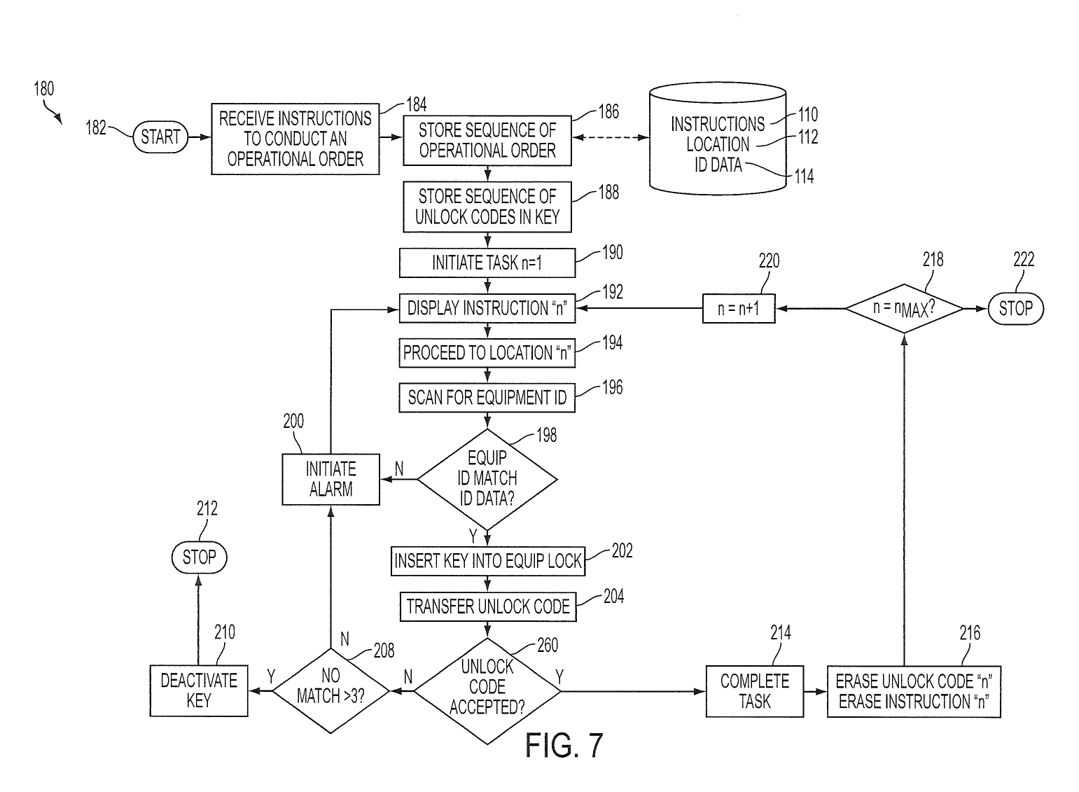

Another method 180 for performing the operational order using both the unit 40 and the key 78 is illustrated in FIG. 7. The method begins in start block 182 and proceeds to block 184 where the instructions to conduct the operational order are received. The sequence of instructions in the operational order is stored in block 186. Each of the steps in the sequence of instructions for the operational order may include multiple data portions, including but not limited to process instruction 110, equipment location 112, and identification data 114. The method 180 then proceeds to block 188 where the sequence of unlock codes is stored in the key 78.

The method 180 then proceeds to block 190 where the personnel initiate the first task and displays the instruction for the task in block 192. The personnel proceed to the location of the first task in block 194 where the identification device 28, such as an RFID tag for example, is scanned in block 196. The method then proceeds to query block 198 where it is determined whether the data from identification device 28 matches the identification data 114. In one embodiment, the query block 198 also compares the current location of the personnel to the location data 112 to determine if the personnel are in substantially the same location as the location data 112. If the data does not match, then the personnel are at the wrong location and the method 180 proceeds to block 200 where an alarm is initiated to alert the personnel. In one embodiment, each time the alarm is initiated, the unit 40 stores this data for later evaluation, such as for examining the effectiveness of personnel training for example. In another embodiment, the initiation of the alarm also causes an alarm to be transmitted to the central control center 34. The method 180 then loops back to block 192 where the instruction is displayed.

If the query block 198 returns a positive, the method 180 proceeds block 202 where the key 78 is inserted into the lock 26. The unlock code is transmitted to the lock 26 in block 204. Query block 206 evaluates whether the unlock code was accepted. If query block 206 returns a negative, the method 180 proceeds to query block 208 to determine if there have been more than three unsuccessful attempts to open a lock. In one embodiment, if there have been more than three unsuccessful attempts to open locks, the method 180 proceeds to block 210 where the key 78 is deactivated and the method 180 terminates in block 212. If the query block 208 returns a negative, the method 180 proceeds to block 200 where an alarm is initiated and loops back to block 192.

If the query block 206 returns a positive, the method 180 proceeds to block 214 where the personnel completes the task. The method 180 then proceeds to block 216 where the unlock code and instruction for the task are erased from the memory of unit 40 and key 78.

The method 180 then proceeds to query block 218 where it is determined whether the task that was just performed was the last task. If the query block 218 returns a negative, the method 180 proceeds to block 220 where the method 180 increments to the next task in the sequence of instructions and loops back to block 192 to initiate the next task. If the query block 218 returns a positive, the method 180 proceeds to termination block 222 and stops.

An embodiment of the method of operating the dispenser may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, universal serial bus (USB) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to provide an apparatus and a method for performing a sequence of instructions in an operational order to minimize the opportunity for personnel to make errors in the performance of the operational order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An instruction and tracking apparatus comprising:
a positioning module;
a reader module;
a display; and,
a controller operably coupled to said positioning module, said reader module and said display, said controller having a processor responsive to executable computer instructions when executed on said processor for displaying a first operational sequence instruction on said display in response to receiving a first signal.

2. The apparatus of claim 1, wherein said processor is further responsive to executable computer instructions when executed on said processor for displaying a second operational sequence instruction on said display in response to receiving a second signal from said positioning module and a third signal from said reader module.

3. The apparatus of claim 2 wherein said positioning module is a global positioning satellite (GPS) module.

4. The apparatus of claim 3 wherein said reader module is responsive to signals from radio-frequency identification (RFID) tags.

5. The apparatus of claim 4 wherein:
said first operational sequence instruction includes a first process instruction and a first lock combination code; and,
said second operational sequence instruction includes a second process instruction and a second lock combination code.

6. The apparatus of claim 5 further comprising a user interface electrically coupled to said controller, wherein said processor is further responsive to executable computer instructions for removing said first process instruction from said display and displaying said second process instruction in response to a fourth signal from said user interface.

7. The apparatus of claim 4 wherein said processor is further responsive to executable computer instructions when executed on said processor for displaying an alarm on said display in response to receiving said second signal from said positioning module and a fifth signal from said reader module.

8. The apparatus of claim 7 further comprising a communications module electrically coupled to said controller, wherein said processor is responsive to executable computer instructions when executed on said processor for transmitting a sixth signal in response to receiving said second signal from said positioning module and said fifth signal from said reader module.

9. An instruction and tracking apparatus comprising:
An instruction unit comprising:
a positioning module;
a reader module;
a display; and,
a first controller operably coupled to said positioning module, said reader module and said display, said first controller having a first processor responsive to executable computer instructions when executed on said first processor for displaying a first process instruction on said display in response to receiving a first signal; and,
a key comprising:
a receiver;
a transmitter; and,
a second controller electrically coupled to said receiver and said transmitter, said second controller having a second processor and memory, said second processor being responsive to executable computer instructions when executed on said second processor for storing a sequence of codes in said memory in response to said first signal.

10. The apparatus of claim 9 wherein said second processor is responsive to executable computer instructions when executed on said second processor for transmitting a first unlock code from said sequence of codes through said transmitter in response to said key being inserted in a lock.

11. The apparatus of claim 10 wherein said second processor is responsive to executable computer instructions when executed on said second processor for erasing said first unlock code from said sequence of codes when said first unlock code is accepted by said lock.

12. The apparatus of claim 11 wherein said first processor is further responsive to executable computer instructions when executed on said first processor for receiving a second signal from said positioning module and a third signal from said reader module, wherein said lock accepts said first unlock code when said second signal is substantially equal to a first position and said third signal is equal to a first unlock code.

13. The apparatus of claim 12 wherein said first processor is further responsive to executable computer instructions when executed on said first processor for displaying a second process instruction in response to said second signal is substantially equal to said first position and said third signal is equal to said first unlock code.

14. A key for use with operational sequence instructions comprising:
a housing;
an engaging member coupled to said housing;
a controller positioned in said housing, said controller having a processor electrically coupled to memory, said processor being responsive to executable computer instructions when executed on said processor for storing a sequence of unlock codes in said memory in response to a first signal, said controller further includes a transmitter electrically coupled between said controller and said engaging member;
wherein said processor is responsive to executable computer instructions when executed on said processor for transmitting a first unlock code from said sequence of unlock codes through said engaging member when said engaging member contacts a first lock, said processor is further responsive to executable computer instructions when executed on said processor for erasing said first unlock code from said sequence of unlock codes when said first unlock code is accepted by said first lock.

15. The key of claim 14 wherein said controller further includes a visual indicator electrically coupled to said processor, wherein said processor is further responsive to executable computer instructions for activating said visual indicator when said first lock does not accept said first unlock code.

16. The key of claim 15 wherein said processor is further responsive to executable computer instructions when executed on said processor for transmitting a second unlock code from said sequence of unlock codes after said first unlock code has been erased and said engaging member contacts a second lock.

17. A method for performing a sequence of operational instructions comprising:
storing said sequence of operational instructions, said sequence of operational instructions includes a process instruction, an equipment identification data and a position where the instruction is to be performed;
displaying a first process instruction associated with a first operational instruction from said sequence of operational instructions, wherein said first operational instruction includes a first position and a first identification data;
determining a second position; and,
receiving an identification signal from a first equipment.

18. The method of claim 17 wherein each of said sequence of operational instructions further includes a lock combination code, wherein said first operational instruction includes a first lock combination code.

19. The method of claim 18 further comprising displaying said first lock combination code when said first position is substantially equal to said second position and said identification signal is substantially equal to said first identification data.

20. The method of claim 19 further comprising displaying a second process instruction associated with a second operational instruction from said sequence of operational instructions, wherein said second operational instruction includes a third position.

21. The method of claim 20 further comprising the step of erasing said first operational instruction after displaying said first lock combination code.

22. The method of claim 17 further comprising:
determining a path from an operators initial position to said first position; and,
initiating an alarm if said second position deviates from said path.

23. A method for performing a sequence of operational instructions comprising:
receiving a set of operational instructions, wherein said set of operational instructions includes a plurality of steps that are executed in order at particular locations;
storing a plurality of unlock codes in a key, wherein each of said plurality of unlock codes is associated with one of said plurality of steps;
transmitting a first unlock code from said plurality of unlock codes when said key is inserted in a first lock;
erasing said first unlock code from said key if said first unlock code is accepted by said first lock; and,
initiating a first alarm if said first unlock code is not accepted by said first lock.

24. The method of claim 23 further comprising:
transmitting a second unlock code from said plurality of unlock codes when said key is inserted in a second lock;
erasing said second unlock code from said key if said second unlock code is accepted by said second lock; and,
initiating a second alarm if said second unlock code is not accepted by said second lock.

25. The method of claim 24 wherein said first alarm is initiated by said key.

26. The method of claim 24 wherein said first alarm is initiated by said first lock when said first lock does not accept said first unlock code and said second alarm is initiated by said second lock when said second lock does not accept said second unlock code.

27. A method for performing a sequence of operational instructions comprising:
storing said sequence of operational instructions in a first memory, said sequence of operational instructions includes a process instruction, an equipment identification data and a position where said process instruction is to be performed;
storing a plurality of unlock codes in a key memory, wherein each of said plurality of unlock codes is associated with one of said sequence of operational instructions;
displaying a first process instruction associated with a first operational instruction from said sequence of operational instructions, wherein said first operational instruction includes said first process instruction, a first position and a first identification data;
determining a second position; and,
receiving an identification signal from a first equipment.

28. The method of claim 27 further comprising transmitting a first unlock code to a first lock on said first equipment, wherein said first unlock code is associated with said first operational instruction.

29. The method of claim 28 further comprising erasing said first unlock code from said key memory when said first unlock code is accepted by said first lock.

30. The method of claim 29 further comprising initiating a first alarm when said identification signal does not equal said first identification data.

31. The method of claim 30 further comprising initiating a second alarm when said first unlock code is not accepted by said first lock.

32. The method of claim 31 further comprising displaying a second process instruction associated with a second operational instruction from said sequence of operational instructions after said identification signal equals said first identification data, wherein said second operational instruction includes said second process instruction, a third position and a second identification data.

33. The method of claim 32 further comprising:
determining a path from said first position to said third position; and,
determining a fourth position; and,
initiating an alarm if said fourth position substantially deviates from said path.
